(19) United States
(12) Patent Application Publication
(10) Pub. No.: US 2008/0192643 A1
(43) Pub. Date: Aug. 14, 2008

(54) METHOD FOR MANAGING SHARED RESOURCES

(75) Inventors: Myung M. Bae, Pleasant Valley, NY (US); Bradley K. Pahlke, Poughkeepsie, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/674,425

(22) Filed: Feb. 13, 2007

(51) Int. Cl. H04J 1/16

(52) U.S. Cl. 370/252; 370/401

(57) ABSTRACT

A method, system and program product for managing resources among a plurality of nodes in a computing environment. An exemplary method includes the operations of collecting information about the resources and their associations with the nodes, making such information available to the other nodes, and reiterating these operations, resulting in maintaining current local and global views for nodes of the resources and providing a method of controlling usage of resources.

### FIELD OF INVENTION

The present invention generally relates to multi-node data processing systems. More particularly, the invention is directed to a mechanism useful for monitoring and controlling resources accessible by a plurality of nodes in a cluster.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

A data processing system that has the capability of sharing resources among a collection of nodes is referred to as a cluster. In clusters, many physical or logical entities are located throughout the entire system of nodes. These entities are referred to as “resources.” The term “resource” is employed very broadly herein to refer to a wide variety of both software and hardware entities. The use of these resources may be sought by and from the system nodes.

Managing shared resources, in particular shared storage resources, is especially relevant for distributed data processing systems. Such systems are highly-available, scalable systems that are utilized in various situations, including those situations that require a high-throughput of work or continuous or nearly continuous availability of the system.

One goal of these high availability clusters is the concept of a continuous application. That is, if an application is running on a first node and that node fails, that application could then be run on a second node. To be able to do this implies both application automation and data automation. With respect to application automation, the application is not a shared entity and therefore running the application on the second node is not problematic, at least in this regard. However, continuity is problematic with respect to data automation since data by its nature is a single entity that is shared among applications. There is a potential for data corruption as applications may run concurrently on two different nodes and require the same resource. For example, a first application running on one node may still be accessing the resource when a second application running on another node begins to access the same resource.

Another related problem that arises when a resource is accessible by more than one node is the correlation of requests to bring that resource online or offline. In the storage arena, there are different types of disks, file systems, etc. For example, a physical disk may contain more than one file system. Therefore, a scenario could arise in which an application running on one node no longer has a need to access data on a specific disk or other resource and a request is received to take that disk or resource offline, but another application on another node is accessing another file system located on that same resource.

Although the above described scenarios are restrictive and merely illustrative and exemplary examples for the purposes of this discussion, one can easily understand how difficult it becomes to manage resources among the nodes of a cluster as the number of resources increase and the relationships of those resources with a node and among nodes becomes very complex.

One important part of ensuring that an application executes well in a cluster, especially a high availability cluster, is to understand configuration information including information as to resources accessible from or otherwise associated with specific nodes and the application's dependencies, including dependencies in terms of resources it requires.

One technique to address this issue is to use a pre-defined written script that describes the configuration information. This script is based on an assumption or a best guess of the resources and how the nodes and the resources are associated. However, this approach does not provide for any updates to be reflected as the cluster operates and, as such, it is inadequate. Consequently, it is desirous to have a method of managing resources shared among nodes that would take into consideration updates to the configuration information and dependencies of applications as the cluster operates.

### BRIEF SUMMARY OF THE INVENTION

In accordance with a preferred embodiment of the present invention, a method is provided for managing at least one resource associated with at least one node of a plurality of nodes in a computing environment. In such preferred embodiment, a daemon process executes on the nodes associated with resources whereby information about the associations of the resource and node (including among other things information about the resource itself) is collected and made available to other nodes in the cluster. The information is characterized and correlated so that operations to be performed with respect to such resource may be allowed or denied based upon the characterized information. The collecting and making available are reiterated as needed.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one example of a computing environment in which aspects of the present invention may be used;

FIG. 2 provides a combined block diagram/functional view of one embodiment of the logic associated with features of the present invention;

FIGS. 3-5 are diagrams illustrating examples of information collected by nodes in a cluster in accordance with aspects of the present invention; and

FIG. 6(a)-(c) illustrates an example of how data protection is provided by features of the present invention.

### DETAILED DESCRIPTION OF THE INVENTION

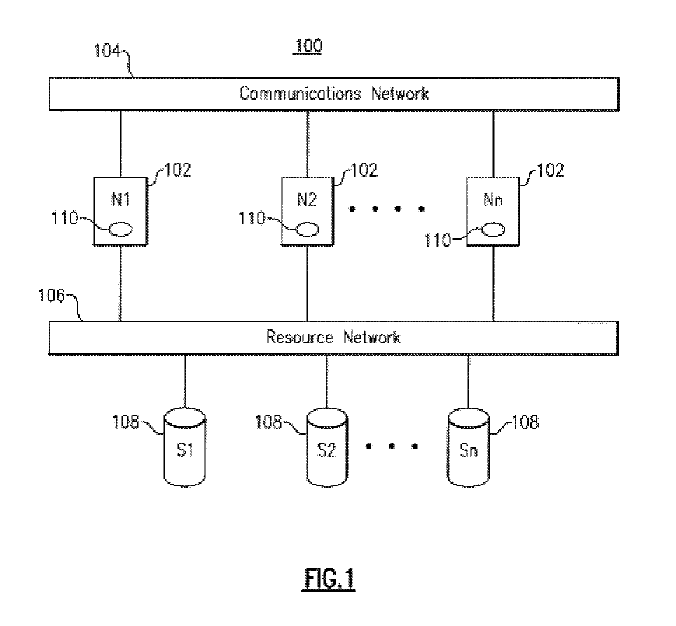

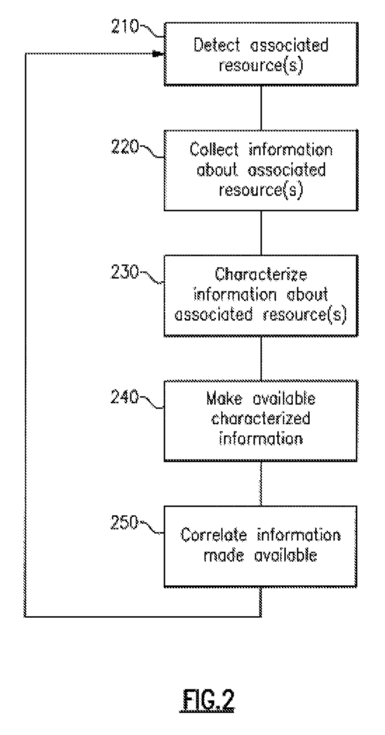

FIG. 1 depicts one embodiment of a computing environment 100. As illustrated in FIG. 1, the computing environment 100 includes a plurality of processing nodes N1 thru Nn 102. A processing node may be, for instance, an IBM® System ρ™ server computer running either LINUX or AIX, examples of Unix-based operating systems. However, nodes 102 do not have to be IBM System ρ servers, nor do they have to run LINUX or AIX. Some or all of the nodes 102 can include different types of computers and/or different operating systems.

Each processing node is coupled to the other processing nodes via communications network 104. Each processing node 102 is also coupled with resource network 106 which in turn is coupled to one or more resources S1 thru Sn 108. Networks 104 and/or 106 may include one or more direct connections from one or more nodes 102 to each other (in the case of communications network 104) or to one or more resources 108 (in the case of resource network 106). Aspects oft he invention are most advantageous when at least two of nodes 102 have access to at least one of the resources 108. In a preferred embodiment of the present invention, as can be seen in FIG. 1, each node 102 includes local process 110 that executes on that node. However, the process need not execute on all nodes in a cluster.

In a preferred embodiment, computer environment 100 is a cluster, more specifically a distributed data processing system, which includes nodes 102 that can share resources and collaborate with each other in performing system tasks. The nodes depicted in computer environment 100 may include all nodes in a cluster or a subset of nodes in a cluster or nodes from among one or more clusters within a computing environment.

International Business Machines Corporation provides a publicly available program product named Reliable Scalable Cluster Technology (RSCT) which includes the Resource Monitoring and Control (RMC) infrastructure, both of which are described in various publications. RMC monitors various resources (e.g., disk space, CPU usage, processor status, application processes, etc.) and performs an action in response to a defined condition. In a preferred embodiment, computer environment 100 comprises an RSCT peer domain or a plurality of nodes configured for, among other reasons, high availability. In a peer domain, all nodes are considered equal and any node can monitor or control (or be monitored and controlled) by any other node.

Referring again to FIG. 1, each of the resource 108 is an instance of a physical or logical entity in computing environment 100. A system or cluster may include numerous resources of various types which may provide a service to another entity or component of the environment. The term resource is therefore viewed very broadly and may refer to a wide variety of software as well as hardware entities. For example, a resource may be a particular file system, a physical disk, a particular host machine, a database table, a specific Internet Protocol (IP) address, logical volumes, volume groups, etc. In a preferred embodiment of a computing environment 100 in which the present invention may be deployed, at least one of resources 108 may be accessed by one or more nodes 102.

In a preferred embodiment, each of resources 108 may have some or all of the following characteristics. A first characteristic is an operational interface used by its clients. For example, the operational interface of a logical volume is the standard open, close, read, and write system calls. A second characteristic is a set of data values that describe some characteristic or configuration of the resource (e.g., file system name, logical volume name, etc.) and that may be referred to as persistent attributes. For example, if the resource is a host machine, its persistent attributes may identify such information as the host name, size of its physical memory, machine type, etc. A third characteristic is a set of data values that reflect the current state or other measurement values of the resource (e.g., the disk block usage of a file system, etc.) and that may be referred to as a dynamic attributes. A fourth characteristic is a resource handle that is a value, unique across time and space, which identifies the resource within the cluster. A fifth characteristic is a set of operations that manipulate the state or configuration of the resource (e.g., an offline operation for a disk, etc.).

A resource class is a set of resources of the same type or of similar characteristics. The resource class provides descriptive information about the properties and characteristics that instances of the resource class can have. Resource classes may represent a physical disk and related storage entities (e.g., the volume group to which the disk belongs, logical volumes into which the volume group is divided, and file systems on logical volumes or disk partitions, etc.). For example, while a resource instance may be a particular file system or particular host machine, a resource class would be the set of file systems, or the set of host machines, respectively.

Each resource class may also have some or all of the following characteristics: a set of data values (which may be referred to as persistent attributes) that describe or control the operation of the resource class; a set of dynamic data values (for example, a value indicating the number of resource instances in the resource class); an access control list that defines permission that authorized users have for manipulating or querying the resource class; and a set of operations to modify or query the resource class. For example, file systems may have identifying characteristics (such as a name), as well as changing characteristics (such as whether or not it is mounted). Each individual resource instance of the resource class will define what its particular characteristic values are (for example, a file system is name “war” and is currently mounted).

It can be appreciated that there may be various dependencies among resources. With respect to storage resources, disks, partitions, volume groups, and file systems are related to each other. For example, a file system may exist on a partition which in turn exists on a physical disk. In order for a node to utilize a file system, the disk on which the file system resides must be available to the node. Moreover, the volume groups in which the volume may be a member of must be online on the node, and the file system must be mounted. The relationship of these storage entities is captured in the resource class attributes of the resource classes and the relationship is different between these resources for various platforms (as will be more clearly seen below).

Although features of the present invention may be illustratively applied in the present disclosure in terms of storage resources, aspects of the present invention are usable with other types of resources. Moreover, the above descriptions of resources and resource classes are merely illustrative. All variations of resources and how such resources are related to nodes and each other are considered a part of the claimed invention.

In the illustrative computer environment of FIG. 1, resources 108 are depicted merely for convenience in the shape of a disk, although, as noted above, a resource is defined much more broadly. For pedagogic clarity in illustrating one embodiment of the present invention, all resources 108 depicted in FIG. 1 are treated in this illustrative environment as being shared resources which may be accessed by all nodes depicted. As can be appreciated, there may be nodes included in a computing environment according to the principles of the invention that do not communicate with other nodes or that do not share resources with all or other nodes.

If the resources 108 are storage resources, resource network 106 is typically a fiber channel storage area network which provides multiple paths from each node to a resource such as disk subsystem. This provides path redundancy for protection if one of the paths to the resource from any node were to fail. If one path were to fail, a new path would be established via an alternate route. The multiple paths from a node to a resource provide highly available access from the node to the resource by having no single point of failure in the data path from the node to the resource. For a resource such as a disk subsystem, this is accomplished with multiple host bus adapters on each node, multiple switches in the resource network and multiple controllers serving access to the disks contained within the disk subsystem. With a plurality of nodes all coupled to the network in the same manner, each node shares this highly available access to the disks contained in the disk subsystems.

In accordance with features of the present invention, process 110 shown in FIG. 1 is a resource manager process. Although for pedagogic clarity process 110 is depicted as a single process in the FIGS. and treated as such in this disclosure, process 110 may be comprised of one or more processes and need not be identical for every node. In a preferred embodiment, process 110 is the storage resource manager application that exploits the RSCT/RMC high available cluster infrastructure to provide management and data protection capabilities for shared storage resources within an RSCT peer domain. In a preferred embodiment, process 110 interfaces between RMC running on each node in the RSCT peer domain and the storage resources in computing environment 100.

In a preferred embodiment, the RSCT peer domain is brought online or made active (i.e., nodes may communicate among themselves) when the “startup quorum” is reached. Quorum refers to the minimum number of nodes within a peer domain that are required to carry out a particular operation. The startup quorum is the number of nodes needed to bring a peer domain online.

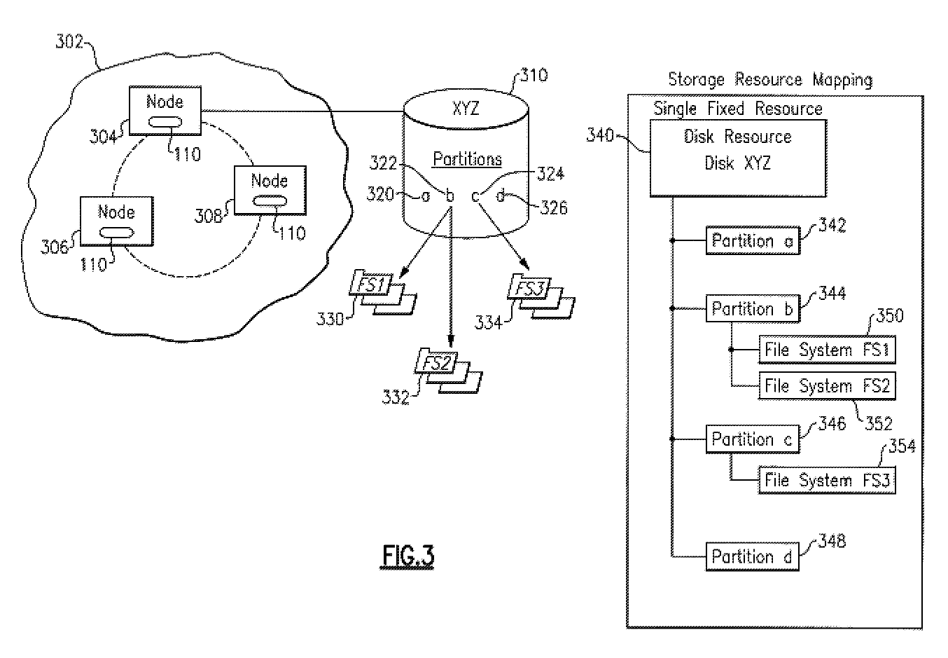

FIG. 2 provides a combined block diagram/functional view of the logic associated with features of one embodiment of the present invention. In the illustrated preferred embodiment, the functional blocks of FIG. 2 correspond to functions of process 110. Referring to block 210 of FIG. 2, at some time after startup of computing environment 100, process 110 executes in each node of a plurality of nodes 102. Process 110 executing in a node detects resource(s) within computing environment 100 that are associated with such node. For example, one association may be the potential for a coupling of that node to that resource.

At block 220, process 110 executing in each node of a plurality of nodes 102 collects information about resource(s) associated with that node. In a preferred embodiment, process 110 is a resource manager process executing as a daemon process on nodes in the RSCT peer domain. This resource manager process collects information about the physical storage entities (for example, attached disks which are locally coupled to a node and those which are shared via a storage area network) and logical storage entities (for example, partitions, volume groups and file systems) within the peer domain. Such information may include some or all of the aforementioned characteristics of the resource, such as resource names, operational interface used by clients that access resource, current state of the resource, etc.

At block 230, the collected information is characterized. A node's local view of resources (including among other things the configuration information of the resources) is created. In a preferred embodiment, process 110 characterizes the collected information by, for example, mapping resources which were detected and/or about which information was collected to instances of the resource classes. As further example, for each storage entity for which information was collected, an instance of one of the resource classes may be created containing information concerning the physical storage device and/or the logical entity.

At block 240, the information which a node has thus characterized is made available to one or more of the remaining nodes 102. Although this can be achieved in several different ways, in a preferred embodiment, process 110 transmits such information to the other node(s) and receives characterized information which was transmitted from the other node(s).

At block 250, process 110 correlates the exchanged information for the node on which it is executing, that is, it correlates the information made available to and the information acquired from another node(s). This correlation provides to each such node a cluster-wide or global view of resources. In a preferred embodiment this correlated information includes information as to which resources are associated with which nodes and the dependencies, if any, among the resources and nodes, for example, information as to how a particular file system is related to a disk.

It can be appreciated by one skilled in the art that a user or application may have the ability to create user/application-defined resources which represent entities not detected by a node or for which no information was previously collected by any node. As described more fully herein, when such a resource is created, information about that resource will become part of the information that is made available to node(s) and correlated.

In a preferred embodiment, as discussed earlier, a resource (e.g., a storage entity, whether physical or logical) can be uniquely identified by a value. This ability to uniquely identify the resource enables process 110 to identify which resources are in fact shared by more than one node by comparing unique identifications of the resources on each node.

Moreover, the correlated information about nodes and their associated resources can preferably and advantageously be acquired from any node in the cluster. This facilitates the goal of high availability in a cluster. For example, in the event that an application requiring a resource is executing on one node and that node fails, any node in the cluster may reference its global view and can determine which node or nodes are coupled to that required resource. The application may then be executed on one of the nodes so coupled. The application itself need not know on which node it is executing.

In accordance with the invention, any one or more of the detection, collection, characterization, making available, and correlation functions described herein (referred to herein as “harvesting functions” or collectively as “harvesting”) are performed repeatedly. The repeated harvesting allows for the monitoring of the resources, updating their current information (e.g., name, properties, etc.) and relationships with other entities in the cluster. The monitoring of a resource includes the activity of maintaining the state of each resource. For example, the monitoring of a file system resource includes the continuous (or periodic) activity of checking the file system resource to determine whether it is still mounted and capable of being used. Moreover, consistent state information of the resources is maintained. For example, if a disk is failed or no longer available, the states of any resources on that disk will also have the implied failed states. Thus, through iterations of harvesting, the resource information will accurately reflect what is in the cluster.

In FIG. 2, the harvesting functions are illustratively reiterated as indicated by the arrow flowing from block 250 to block 210. In a preferred embodiment, such harvesting functions are reiterated at specified times (e.g., upon startup, after expiration of a time period that is either predetermined or dynamically determined, etc.) or on command or upon any modification or change to the previously detected resources and related information, or as determined by an operator, user, cluster manager or an application, or upon the occurrence of a specified event. In alternate arrangements, any one of these harvesting functions may occur at separately specified intervals for each resource class or group of resource classes, or for specified resources.

The reiteration of the harvesting functions result in updating and maintaining the local and global views of the node(s) of the cluster with respect to resources within the cluster. By maintaining these views, newly attached physical resources and newly formatted logical resources are detected, as well as any removal of these resources or charges in their configurations or other characteristics.

The advantages of a preferred embodiment of the present invention can easily be appreciated. As an example, an application that is to run on a cluster need only specify the resource (e.g., file system name) it requires. The application need not be concerned with, for example, configuration information or physical implementations of the resource it requests (e.g., what disks to mount or volume groups to vary on), or which node in the cluster may execute the application. The nodes in the cluster have a global view of resources and, for example, can identify which physical disks are coupled to which nodes in the cluster. Thus an application can execute on any node that has access to the needed resource. As referred to above, if that node should fail, the application can be moved to another node similarly associated with the resource. The application need not be modified; the application need not know on which node it is running or where in the cluster are the resources it requests. In other words, there is a separation between the physical implementation of the resources an the application's abstract, higher view of the resources. The relationship between an application and the resources it requires is thereby simplified.

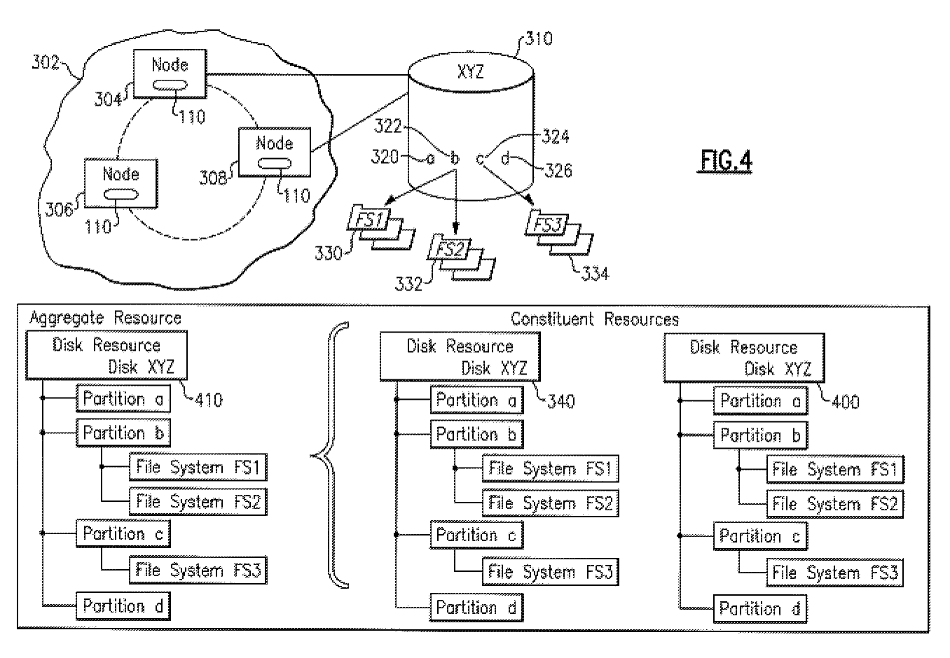

FIGS. 3-5 illustrate examples of information collected, characterized, made available and correlated by nodes in a cluster in accordance with aspects of the present invention.

FIG. 3 assumes a computing environment 100 consisting of a Linux cluster 302 comprised of three nodes, Node 304, Node 306, and Node 308, all of which are intercoupled and in a preferred embodiment, comprise a RSCT peer domain. For clarity, only three nodes are illustrated in the FIGS. 3-5 although an arrangement embodying the features of the invention may support any number of nodes. Only Node 304 is coupled to physical disk, Disk XYZ 310. Disk XYZ 310 is comprised of four partitions: a 320, b 322, c 324, and d 326. File systems FS1 330 and FS2 332 reside on partition b and file systems FS3 334 resides on partition c.

In accordance with the features of this invention, process 110 running on Node 304 detects physical Disk XYZ 310 and collects and characterizes information about Disk XYZ 330. Such information will be mapped, for example, to an instance of the Disk resource class 340. The mapping 340 indicates the physical disk identifier (XYZ) of this instance 340 of the Disk resource class. Partitions a 320, b 332, c 324, and d 326 are mapped to instances 342, 344, 346, and 348, respectively, of the Partition resource class. In similar manner, file systems FS1 330, FS2 332, and FS3 334 are mapped to instances 350, 352 and 354, respectively, of the File system resource class.

In a preferred embodiment, instances of resource classes may be fixed or constituent resource instances or global, or aggregate, resource instances. A global, or aggregate, resource instance is a global representation of all the constituent resource instances that represent the same resource entity. Resources that are specific to a particular node are fixed resources; either a single-fixed resource that is coupled to that node only or a constituent resource of an aggregate resource when the resource can be accessed by other nodes.

In FIG. 3, instance 340 of the Disk resource class contains configuration information specific to Disk XYZ 310 coupled to Node 304. In this case, resource Disk XYZ 310 is a single fixed resource and can be identified as such via its type and the list of nodes that Disk XYZ 310 is attached to. According to the features of the invention, Node 306 and Node 308 are made aware of resource mapping 340. However, no global, or aggregate, resource instance is created since Disk XYZ 310 is coupled to only one node, Node 304.

Let us assume that physical Disk XYZ 310 becomes coupled to Node 308 as well as Node 304, as is shown in FIG. 4. According to the features of the invention, process 110 executing on Node 308 detects the newly coupled resource physical Disk XYZ 310 and collects information about that resource. In particular, a single fixed resource instance 400 will be created to reflect the configuration of Disk XYZ 310, as was described above with respect to Node 304. Information about Disk XYZ 310 is shared among all three nodes 304, 306, and 308. Each node correlates such shared information (using unique identification) and will create an instance 410 of the Disk resource class that is now referred to as an aggregate, or globalized, resource instance. Although the instances 340 and 400 are specific to a particular node, Node 304 and Node 308, respectively, Disk XYZ is now accessible by more than one node. The single fixed resource instance 340 and the single fixed resource instance 400 are now referred to as constituent resource instances. Therefore, in this case, there are three instances of the Disk resource class: two constituent instances 340 and 400, and one aggregate resource instance 410.

According to the principles of the present invention in a preferred embodiment, all three instances 410, 340 and 400 may be queried from any node in the peer domain. Moreover, commands issued with respect to the aggregate resource instance will affect its constituent resource instances. This advantageously enables an efficient method of managing global resources from any node in the peer domain. The resource can be managed as one shared resource (using the aggregate resource instance) or as a single resource on one node (using the constituent instance for a particular node).

It is to be appreciated that there are different relationships among the resource entities and therefore resource entities may be mapped to resource classes in various ways. For example, mappings may differ as a function of the type of cluster or as a function of the relationships or dependencies among resources and resource classes. As was noted earlier, the relationship among resource and resource classes may differ depending on the platform utilized.

Moreover, as mentioned above, a user or application on a node may have the ability to create user/application-defined resources which represent entities not detected or for which no information was previously collected by any node. For example, a user/application may require that a network mounted file system be monitored as a global resource within a peer domain. In this case, process 110 may create an instance of the FileSystem resource class which is independent of existing, already collected, device information. However, once this instance is created, it becomes part of the information about an associated resource that is then made available to other mode(s) and correlated.

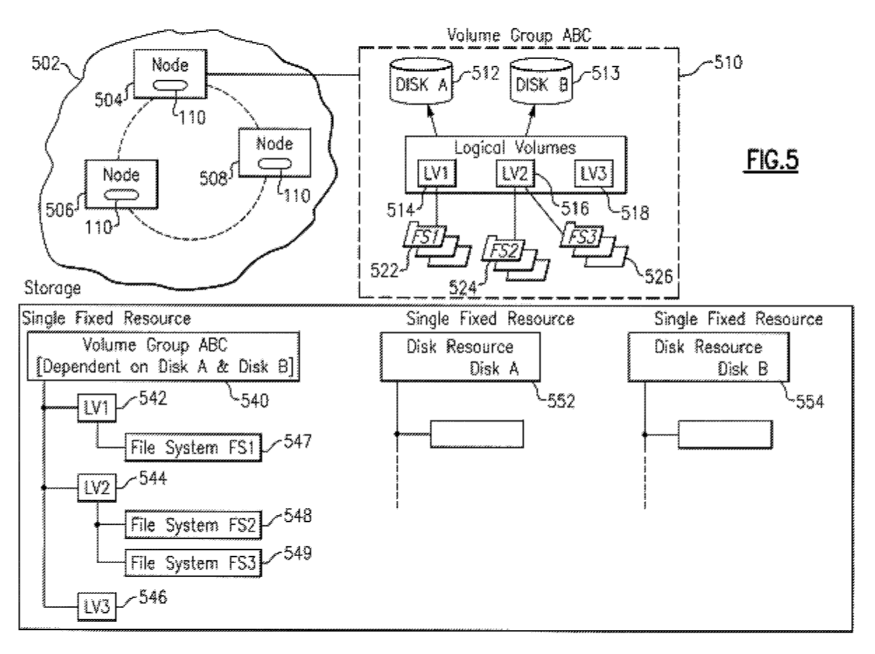

FIG. 5 illustrates an AIX cluster 502 comprised of three nodes 504, 506, 508 making up an RSCT peer domain. In FIG. 5, Node 504 is coupled to Volume Group ABC 510 which is comprised of two physical disks, Disk A 512 and Disk B 513. Three logical volumes, LV1 514, LV2 516, and LV3 518 are configured on Volume Group ABC 510. There is one file system FS1 522 on logical volume LV1 514, and two file systems, FS2 524 and FS3 526, on logical volume LV2 516.

Process 110 executing on Node 504 detects Volume Group ABC 510 and proceeds to collect information about Volume Group ABC 510. After collection, the information is characterized. In particular, a single fixed resource instance 540 reflecting Volume Group ABC 510 is created. Information contained in instance 540 indicates that Volume Group ABC 510 is dependent on two physical disks, DiskA 512 and DiskB 513. Two Disk resource instances 552 and 554 are created to correspond with DiskA 512 and DiskB 513, respectively. Logical Volume instances 542, 544 and 546 of the Logical Volume resource class are created for LV1 514, LV2 516, and LV3 518, respectively. In like manner, instances 547, 548 and 549 of the FileSystem resource class are created for file systems FS1 522, FS2 524 and FS3 526, respectively.

According to the features of the present invention, node 504 communicates this characterized information to nodes 506 and 508 and obtains from nodes 506 and 508 information that was characterized by these nodes, respectively. Node 504 correlates all information received and sent.

As noted above, advantageously, in accordance with the principles of the invention, the resources associated with nodes in a cluster may be monitored, and information about such resources and about their association with the nodes and other cluster entities is updated accordingly. In particular, information about these resources and their associations within a node and among nodes can be made to reflect various states as that information and associations change.

As an example, if a previously-harvested resource is not detected by a subsequent harvest operation, the instance(s) of that resource can be deleted. Alternatively, instead of deleting the instance(s) of that resource, an indicator may be associated with the instance(s) that identifies the resource as a “ghost resource” or something that may no longer represent an actual resource entity. For example, the marking of the resource as a “ghost resource” may indicate that the resource was removed or may indicate that the resource is only temporarily unavailable. If a subsequent harvest operation detects that the resource is now available, the instance is no longer marked as a “ghost resource”.

Alternatively, a node may allow or deny an operation on a resource at least in part as a function of its global view of the resources. As a specific example, the information about resources, including without limitation the relationships among such resources, captured by the global views may be utilized by applications in creating use policies, such as, for examples, date use policies or automated failover policies for shared storage devices within a cluster such as an RSCT peer domain.

According to the features of the invention, an application that is running on one node which fails can advantageously be easily moved to another node that is known to have access to the resources required by that application. This is due in part to the fact that information about the global view of the resources may be obtained from another node or nodes in the cluster.

As mentioned earlier, in a shared resource environment, multiple nodes within the cluster may have access to the same resources. Typically, in particular in a shared storage resource environment, a resource can be brought “online” or “offline” by an application or by command from a cluster manager. For each resource class, the terms “online” and “offline” have different meanings depending on the entity that the resource class represents. For example, with respect to the Disk resource class, the online operation reserves (makes available to a node) the disk and the offline operation releases it; the reserve and release operations may be implemented using Small Computer System Interface (SCSI) reserves and releases. With respect to the FileSystem resource class, the online operation mounts the file system and the offline operation unmounts it. With respect to the VolumeGroup resource class in the AIX environment, the online operation activates the volume group and the offline operation deactivates it.

As per one embodiment of the present invention, data protection may be provided by, for example, managing the multiple resources depending on or contained in the same resource. A “use” indicator is provided for each resource in a resource class. This indicator is turned on by a request for that resource and therefore when turned on, indicates that the resource is in use. When that resource is no longer in use, the indicator is turned off. A resource can be used only if the resources which it depends on or resources that may contain the requested resource may also be used. In a similar fashion, a resource may be placed offline only if there are no resources being used that are contained in or dependent on such resource to be placed offline.

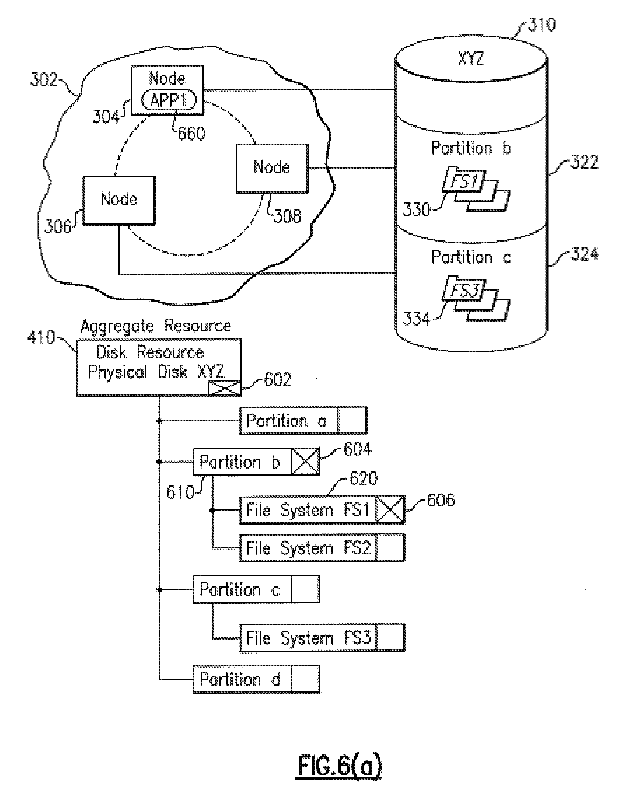

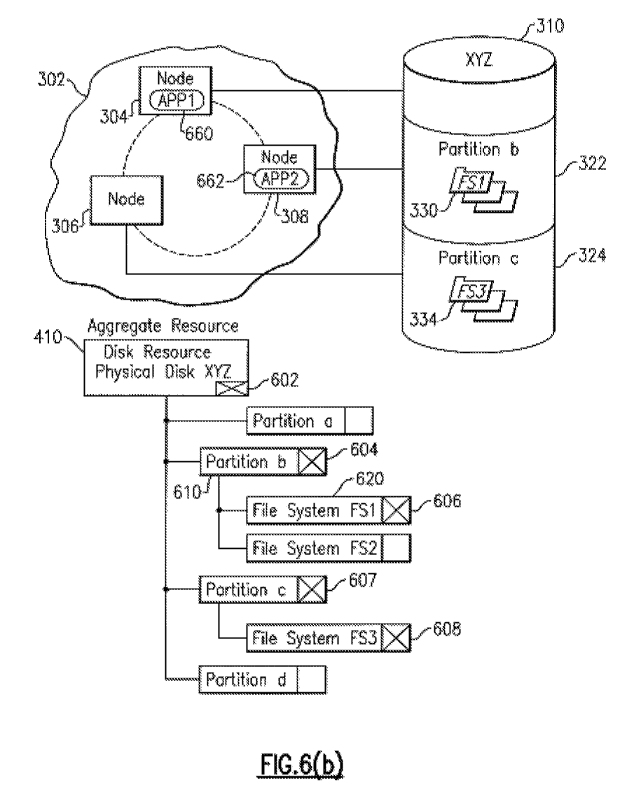

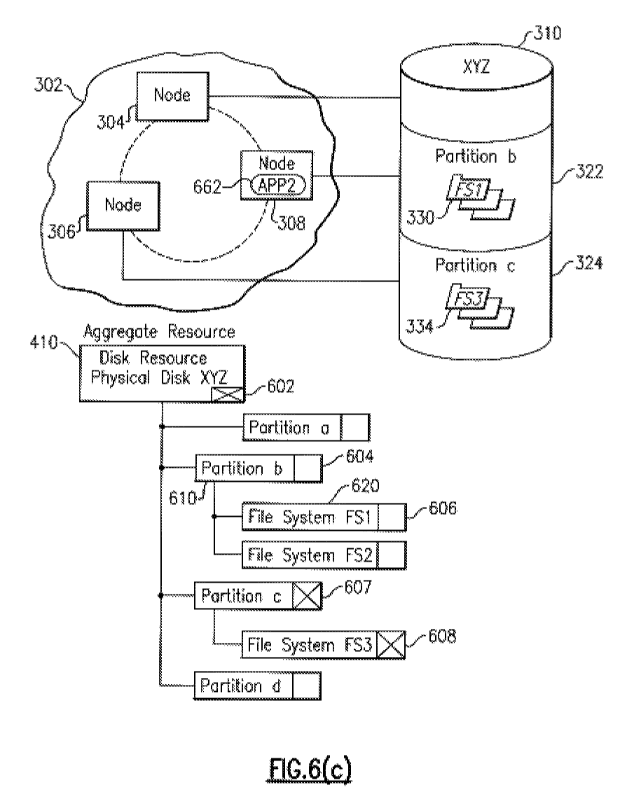

FIG. 6(a)-(c) illustrates an example of data protection provided by the features of the present invention. FIG. 6(a) depicts cluster environment 302 of FIG. 4 but now with node 306 also coupled to Disk XYZ 310. Application APP1 660 is executing on node 304 and application APP2 662 is executing on node 308. Application APP1 660, running on node 304, requests for use file system FS1 330. Accordingly, this request for FS1 330 generates a request to bring Partition b 332 that contains FS1 330 online. This request for partition b 332 in turn generates a request to bring Disk XYZ 310 online.

Assuming the operation to bring the disk online may be performed (for example, Disk XYZ 310 is not already reserved by another node such as Nod 306), Disk XYZ 310 will be brought online and Partition b 322 and FS1 330 will be mounted. The use indicator 602 in the aggregate resource instance 410 for Disk XYZ 310 will indicate that this resource is in use, as denoted by the “X” mark. Similarly, the use indicators 604 and 606 for instances 610, and 620 of Partition b 322 and file system FS1 330 respectively will indicate that these resources are in use. Although not depicted for simplicity reasons in FIG. 6, it can be appreciated that the constituent resource 340 of Node 304 would similarly indicate that the foregoing resources are in use. According to the features of the present invention, the information regarding these resources and their usage will be made available to one or more other nodes in the cluster (in this case nodes 304, 306, and 308) during the next harvesting. In this manner, multiple nodes have access to this now updated resource mapping.

Referring now to FIG. 6(b), let us assume that application APP2 662, executing on node 308 requires file system FS3 334 on partition c 324. In similar fashion to that described above for App1 660, the use indicators 607 and 608 for partition c 324 and FS3 334 respectively indicate that these resources are in use (as denoted by the “X” mark). The information in the constituent resource 400 for node 308 is updated to indicate usage. The updated information will also be made available to other node(s) in the next harvesting, in particular to node 304. Moreover, according to the features of the invention, the status of these resources will be measured to ensure that they remain online for as long as the resources are required.

As a result, for example, upon the completion of App1, disk XYZ 310 is not brought offline because App2 662, which continues to execute on node 308, requires this resource to be online. In particular, upon completion of App1 660, a request to unmount file system FS1 330 is generated. The use indicator 606 in resource instance 620 for FS1 330 is now set to indicate no usage as depicted by the removal of the “X” mark in FIG. 6(c). The instance of the constituent resource 340 is also updated, although not shown in this FIG. 6.

In addition, a request to offline partition b 322 is generated. The offline operation is performed because there is no other use associated with partition b 322, as is indicated by the removal of the “X” mark in use indicator 604. A request to perform the offline operation on Disk XYZ is also generated. However, this request is not allowed by node 304. Node 304 had been made aware of the relationship between Node 308 and resource Disk XYZ from the prior harvesting operations. Disk XYZ 310 is not placed offline because App2 662 continues to execute and require FS3 34 in Partition c 324 on disk XYZ 310. The use indicator 602 in the resource instance 410 continues to indicate the use of FS3 334 on disk XYZ 310. Subsequent harvesting updates the nodes' views of the resources after the completion of App1 660 such that all three nodes 304, 306, and 308 are made aware of the use and non-use of the resources. Although not denoted in FIG. 6, the constitute resources instances are also updated accordingly.

Although the foregoing is an illustration of one embodiment of the present invention, such embodiment is only provided to ease understanding and other embodiments are achievable. Moreover, it can be appreciated that the principles of the invention advantageously provide that application need not be aware of the offline/online processes and simplify the task of managing resources and their relationships within a node and among nodes.

The foregoing detailed description has disclosed to those of ordinary skill in the art a mechanism to monitor and control resources shared among nodes in a cluster. Although the embodiment disclosed herein is the best presently known to the inventors, it will be immediately apparent to those skilled in the art that systems employing the basic principles of the one disclosed herein may be implemented in many ways. In particular, the computing environment need not be a distributed data processing system, nor do all the nodes in a cluster need participate in any one of the harvesting functions or method steps to be able to communicate with each other. Although the embodiments presented above were in the storage context, a resource may be any entity that a node may access. Moreover there may be many different relationships among such resources and within a node and among multiple nodes than the few mentioned in this disclosure.

All of the above being the case, the foregoing detailed description is to be understood as being made only by way of example and not as a limitation to the scope of the invention. Accordingly, it is intended by the appending claims to cover all modifications of the invention which fall within the true spirit and scope of the invention.

What is claimed is:

1. In a computing environment having a plurality of nodes, a method of resource management, comprising the steps of:
collecting information about the associations of a resource and at least one node:
making available said collected information to one or more other nodes; and
reiterating above steps as needed.

2. The method of claim 1 wherein said method is further comprised of the step of determining whether to allow an operation to be performed on said resource as a function of said collected information.

3. The method of claim 2 wherein said method is further comprised of the steps of detecting the at least one resource associated with the at least one node, characterizing the collected information to be made available and correlating the information made available.

4. The method of claim 3 wherein the making available comprises the steps of said at least one node sending said characterized information to at least one other node of the plurality of nodes and receiving information collected by said at least one other node.

5. The method of claim 3 wherein said any one of said steps of detecting, collecting, characterizing, making available and correlating are reiteratively performed.

6. The method of claim 3 wherein said characterizing includes the step of associating said resource with at least one resource class, and said determining is performed further as a function of said resource class.

7. A data processing system having a plurality of nodes associated with at least one resource, said nodes containing executable instructions for causing each node to carry out the steps of:
detecting associated resource;
collecting information about said associated resource;
characterizing said collection information;
making said characterized information available to other nodes in the plurality of nodes,
correlating said information made available by nodes, and
reiterating above steps as needed.

8. The method of claim 7 in which said method is further comprises of the step of allowing operations to be performed on said at least one resource responsive to said correlated information.

9. The method of claim 8 in which said making available includes the sending of said characterized information and the receiving of information characterized by other nodes.

10. The method of claim 8 in which said reiteratively performing is performed at specified intervals or upon the occurrence of a specified event.

11. The method of claim 8 in which said correlated information includes information as to the association of said resource with a resource class.

12. The method of claim 11 in which the allowing step is a function of said resource class.

13. The method of claim 8 in which the characterized information includes information about the relationship of the resource to the node and to other resources associated with the node.

14. The method of claim 8 in which said correlated information includes information about the relationship of the resource among nodes.

15. A computer program product for use in a computing environment comprised of at least two nodes associated with a resource, such product comprising a computer useable medium having a computer readable program, wherein the computer readable program when executed on a first node causes the first node to:
collect information about a first association of the resource and the first node;
allow said collected information to be made available to said second node;
receive information about a second association of said resource and said second node;
reiteratively perform zero or more times said collecting, allowing and receiving.

16. The product of claim 15 in which said first node is further causes to characterize said information collected about said first association and to correlate said information about said first and second associations.

17. The product of claim 16 in which the first node is further caused to allow an operation to be performed by first said node on said resource as a function of said correlated information about first and second associations.

18. The product of claim 16 in which the first node is further causes to reiterately perform at specified intervals or upon the occurrence of a specified event.

19. The product of claim 17 in which such information about an association includes an indication of whether resource is in use by said associated node.

20. The product of claim 17 in which the characterizing includes the associating said resource with at least one resource class and the allowing is further a function of said resource class.
